(19) United States
(12) Patent Application Publication
(10) Pub. No.: US 2013/0304609 A1
(43) Pub. Date: Nov. 14, 2013

(54) Interactive Shopping List System

(71) Applicant: Keo Keonorasak, San Francisco, CA (US)

(72) Inventor: Keo Keonorasak, San Francisco, CA (US)

(73) Assignee: Wal-Mart Stores, Inc., Bentonville, AR (US)

(21) Appl. No.: 13/468,361

(22) Filed: May 10, 2012

(51) Int. Cl. G06Q 30/00

(52) U.S. Cl. 705/26.8

(57) ABSTRACT

Exemplary embodiments of the present disclosure are directed to generating a shopping list via a retail entity's website and outputting the shopping list to a portable electronic device that can be carried by a user in a physical retail location as a user shops for products. Exemplary embodiments can include a shopping list generation system that can generate a shopping list data structure and/or a shopping list reception system that can receive and process contents portion of the shopping list data structure to display a shopping list on a portable electronic device.

### BACKGROUND

Consumers often visit websites of retailers to view products available for purchase from the retailer before buying the products at a physical retail location. In a sense, consumers can use the Internet to “window shop” from the comfort of their own homes before going to the store to view the products in person and/or purchase the products. While it has become common for consumers to view and purchase products online, some consumers still prefer to purchase products from physical retail locations. For example, some consumers may prefer to see the products before they purchase it, ask sales associates questions about the products, find other products similar to the product in which they are interested, and so on.

### SUMMARY

Exemplary embodiments of the present disclosure are directed to generating a shopping list via a retail entity's website and outputting the shopping list to a portable electronic device that can be carried by a user in a physical retail location as a user shops for products included in the shopping list. Exemplary embodiments can include a shopping list generation system that can generate a shopping list data structure and/or a shopping list reception system that can receive and process contents portion of the shopping list data structure to display a shopping list on a portable electronic device.

In one embodiment, a method of processing a user selection on a retail website and transmitting information corresponding to the user selection to a portable electronic device in an electronic commerce environment is disclosed. The method includes receiving a user selection from a user via a web browser. The user selection is associated with a selected product displayed via a web page of a retail website. The method further includes writing information related to the selected product into a contents portion of a shopping list data structure in response to the user selection, and transmitting the contents portion of the shopping list data structure to a portable electronic device via a data communications network.

In another embodiment, a non-transitory computer readable medium storing processor executable instructions is disclosed. Execution of the instructions by a processing device causes the processing device to receive a user selection from a user via a web browser. The user selection is associated with a selected product displayed via a web page of a retail website. Execution of the instructions by a processing device causes the processing device to write information related to a selected product into a contents portion of a shopping list data structure in response to a user selection via the web browser, the user selection being associated with the selected product and transmit the contents portion of the shopping list data structure to a portable electronic device via a data communications network.

In yet another embodiment, a system for electronic commerce associated with a website is disclosed. The system includes a network interface and a configurable processing device. The network interface is communicatively coupled to a communications network and the configurable processing device is communicatively coupled to the network interface. The processing device is configured to receive a user selection over the communications network from a user via the network interface. The user selection corresponds to a selected product displayed on a web page of a retail website by a web browser. The processing device is also configured to write information related to the selected product into a contents portion of a shopping list data structure in response to the user selection and transmit the contents portion of the shopping list data structure to a portable electronic device via the network interface.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an exemplary embodiment of a shopping list generation system.

FIG. 2 is a block diagram of an exemplary embodiment of a shopping list reception system implemented by a portable electronic device.

FIG. 3 is a flowchart of an exemplary shopping list generation process implemented by embodiments of the shopping list generation system.

FIG. 4 is a flowchart of another exemplary shopping list generation process implemented by embodiments of the shopping list generation system.

FIG. 5 is a flowchart of another exemplary shopping list generation process implemented by embodiments of the shopping list generation system.

FIG. 6 is a flowchart of an exemplary shopping list display process implemented by embodiments of the shopping list reception system.

FIG. 7 is a flowchart of another exemplary shopping list display process implemented by embodiments of the shopping list reception system.

FIG. 8 is a flowchart of another exemplary shopping list display process implemented by embodiments of the shopping list reception system.

FIG. 9 is an exemplary GUI that can be provided by an exemplary embodiment of the shopping list generation system.

FIG. 10 is an exemplary shopping list that can be displayed on a portable electronic device.

FIG. 11 is another exemplary shopping list that can be displayed on a portable electronic device.

FIG. 12 is an exemplary layout of a physical retail location that can be displayed on a portable electronic device using information in a shopping list received by the portable electronic device.

FIG. 13 is a block diagram of an exemplary computing device for implementing embodiments of the shopping list generation system and/or the shopping list reception system.

FIG. 14 is a block diagram of an exemplary computing system for implementing embodiments of the shopping list system and/or the shopping list reception system.

### DESCRIPTION OF EXEMPLARY EMBODIMENTS

Exemplary embodiments of the present disclosure are directed to generating a shopping list in an electronic commerce environment via a retail entity's website and outputting the shopping list to a portable electronic device that can be carried by a user in a physical retail location of the entity as a user shops for products included in the shopping list.

Exemplary embodiments can include a shopping list generation system that can be programmed and/or include executable code to generate a shopping list data structure and write information into the contents portion of the data structure corresponding to products to be added to the shopping list. The contents portion of the shopping list data structure can be output to a portable electronic device in one or more formats.

Exemplary embodiments can include a shopping list reception system implemented on a portable electronic device to process the contents portion of the shopping list data structure received by the portable electronic device. Exemplary embodiments of the shopping list reception system can be programmed and/or include executable code to provide an interactive environment through which the user can interact with a shopping list corresponding to the contents portion of the shopping list data structure received by the portable electronic device.

Exemplary embodiments can advantageously allow a consumer to review a retail entity's product offering using the retail entity's website and then add products to be viewed and/or purchased at a physical retail location of the entity to a shopping list. The shopping list can be output to the consumer or another consumer's portable electronic device so that when or while the consumer visits the physical retail location the consumer can refer to the shopping list. Exemplary embodiments can advantageously allow a consumer to interact with a shopping list received by their portable electronic device so that the portable electronic device can keep track of which products the consumer has obtained.

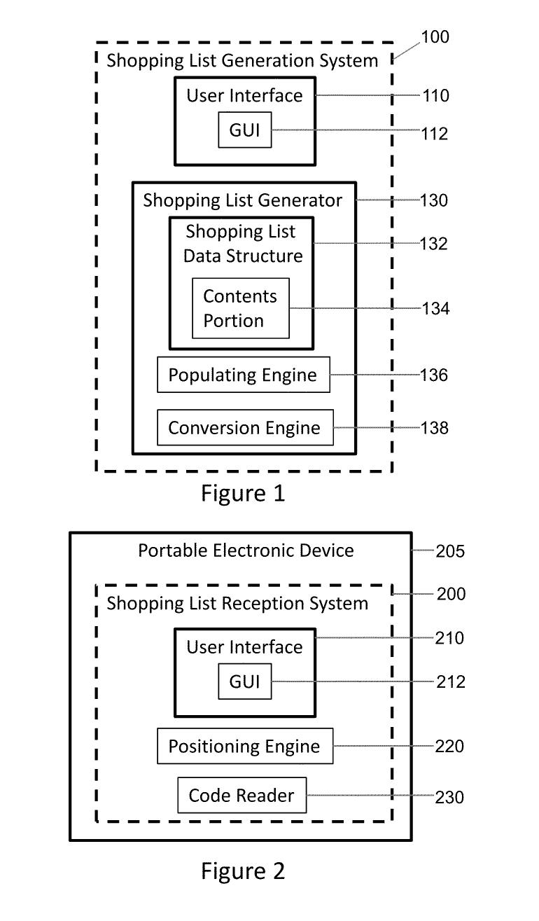

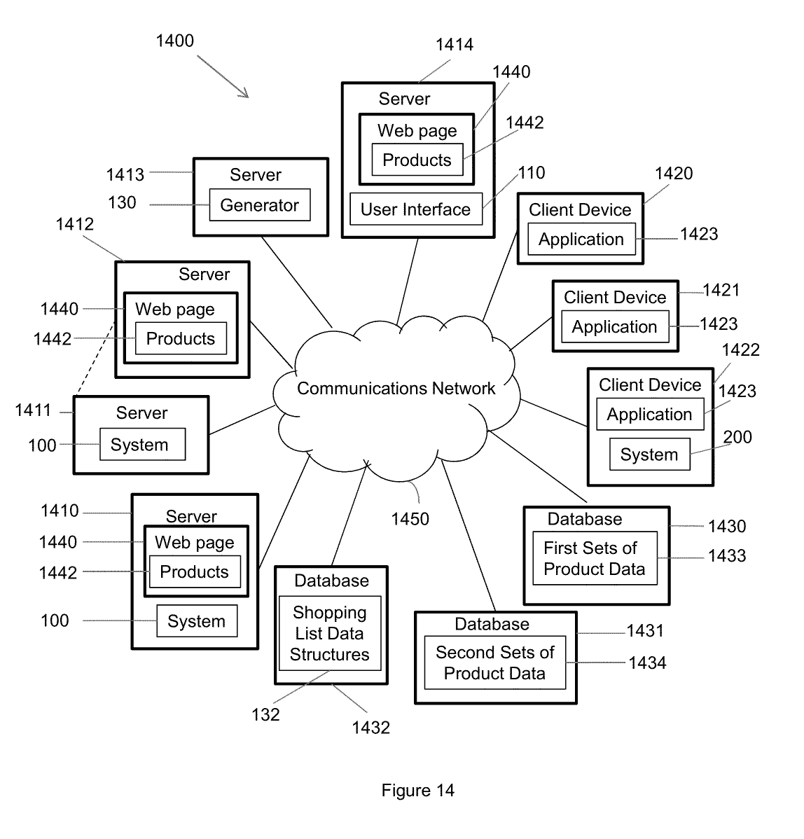

FIG. 1 is a block diagram of an exemplary shopping list generation system 100 (hereinafter “system 100”). Exemplary embodiments of the system 100 can be implemented using hardware, software, and/or a combination thereof. For example, in one exemplary embodiment, a computing device, such as a server, can be configured to implement exemplary embodiments of the system 100. An exemplary server is depicted in, for example, FIG. 14. The system 100 can include a user interface 110 and a shopping list generator 130. The system 100 can be programmed and/or include executable code to process user selections via a web page of a retail website to generate a shopping list of products available for purchase at a physical retail location associated with the retail website and to output the shopping list to a portable electronic device that can be carried through the physical retail location by a user.

The user interface 110 can be programmed and/or include executable code to provide a graphical user interface (GUI) 112 through which a user can interact with the system 100. As an example, in some embodiments, the GUI 112 can be associated with and/or embedded in a retail entity's website such that the GUI 112 can be displayed to the user via a web page of the retail entity's website. The web page can display product data associated with products available for purchase from the retail entity. For example, a server hosting the website can be programmed and/or include executable code to receive product data for the products available for purchase. The product data can be retrieved from a database in response to a query from a user. The product data can correspond to products available for purchase online via the website and/or at a physical retail location. In exemplary embodiments, the product data can include, for example, a name of the product, a price of the product, a description of the product, a model number associated with the product, a stock-keeping unit (SKU) number associated with the product, an image of the product, and/or any other data associated with the product including, for example, product reviews, product ratings, and/or product specifications.

The user interface 110 can be programmed and/or include executable code to allow a user to generate a shopping list, select products to be added to the shopping list, add the products to the shopping list, select products to remove from the shopping list, remove the products from the shopping list, and/or can be programmed and/or include executable code to allow the user to modify the shopping list, for example, by changing one or more parameters associated with the shopping list, such as increasing or decreasing a quantity associated with a product in the shopping list and/or adding or updating a destination of the shopping list (e.g., a telephone number or e-mail address to which the shopping list is transmitted).

The shopping list generator 130 can interface with the user interface 110 and can be programmed and/or include executable code to receive and/or process inputs from the user received via the web page. The generator 130 can be programmed and/or include executable code to generate shopping list data structures 132. The shopping list data structures 132 can be implemented in or more formats including text files, Extensible Mark-up Language (XML) files, a Hypertext Mark-up Language (HTML) files, records in a database, and/or any other suitable data structure or structures. A new shopping list data structure can be generated for a user for each time the user visits the website and/or shopping list data structure 132 associated with a user's account can be maintained so that previous shopping lists can be available for subsequent use by the user. As one example, a user can select a generate shopping list GUI button (e.g., a link) from a web page of the website and the generator 130 can be programmed and/or include executable code to generate a shopping list data structure 132. As another example, the user can select an add product to shopping list link from a web page and the generator 130 can be programmed and/or include executable code to generate a shopping list data structure 132 and add information related to the product to contents portion 134 of the shopping list data structure 132. As yet another example, the user can select a retrieve shopping list(s) link from a web page and shopping lists maintained by the generator 130 can be displayed to the user via the user interface 110. The generator 130 can include a populating engine 136 and a conversion engine 138.

The populating engine 136 of the generator 130 can be programmed and/or include executable code to insert information related to the products in, and/or remove information related to the products from, the contents portion 134 of the shopping list data structure 132 in response to user inputs received via the user interface 110. In one embodiment, upon a selection by the user to add a product to the shopping list, the populating engine 136 can be programmed and/or include executable code to write information related to the product into the contents portion 134 of the shopping list data structure 132. In some embodiments, the information written into the shopping list data structure 132 can correspond to the product data displayed on the web page of the website. For example, a sub-set of the product data displayed on the web page of the website can be written into the shopping list data structure 132. In some embodiments, when the server receives the set of product data for display on the web page of the website, the server can also receive a separate set of product data such that the separate set of product data is available for use by the system 100. The populating engine 136 can programmed and/or include executable code to write the separate data set into the contents portion 134 of the shopping list data structure 132 in response to a user selection. In some embodiments, the separate set of product data can be stored in the database until a user selection corresponding to the separate set of product data is made, at which time, the populating engine 136 can be programmed and/or include executable code to construct a query using a database querying language to query the database for a separate set of product data, retrieve the separate set of product data from the database, and insert the separate data set into the contents portion 134 of the shopping list data structure 132 in response to the user selection.

The separate set of product data can correspond to the product and can include data that is different than and/or in a different format than the product data retrieved for display on the website. The separate set of product data can include, for example, a name of the product, a price of the product, a description of the product, a model number associated with the product, a SKU number associated with the product, an image of the product, an isle at which the product is located in the physical retail location, quick response (QR) code and/or bar code information associated with the product, and/or any other data associated with the product. The set of product data retrieved for display and the separate set of product data to be inserted into the shopping list data structure can have overlapping product data and/or non-overlapping product data. Overlapping product data corresponds to product data in the first set that intersects with product data in the second set (i.e., product data common between the first and second set) and non-overlapping product data correspond to product data in the first set that does not intersect with product data in the second set (i.e., disparate product data between the first and second sets). The separate set of product data can have a different file format than the set of product data retrieved for display on the website. The separate set of product data can be in a compressed file format and/or can have memory size that is less than the memory size of the set of product data retrieved for display on the website.

Exemplary embodiments of the system 100 can be programmed and/or include executable code to allow a user to transmit the contents portion of the shopping list data structure in one or more formats. For example, in exemplary embodiments, the contents portion of the shopping list data structure can be transmitted in a messaging format, an e-mail format, a format corresponding to an application implemented on the portable electronic device, and/or any other suitable format. For embodiments in which the contents portion of the shopping list data structure can be output in a messaging format, the contents portion can be output as a text message using, for example, a short message service (SMS) protocol, and/or a multimedia message using, for example, a multimedia messaging service (MMS) protocol.

The conversion engine 138 can be programmed and/or include executable code to convert the contents portion of the shopping list data structure to a specified format. For example, in some embodiments, the system 100 can be programmed and/or include executable code to convert the contents portion of the shopping list data structure to an SMS format, an MMS format, a format corresponding to an application implemented on the portable electronic device, and/or any other suitable format. In some embodiments, the format in which the contents portion of the shopping list data structure is transmitted can be specified by the system 100. In some embodiments, the format in which the contents portion of the shopping list data structure is transmitted can be selected by the user. For embodiments in which the format can be selected by the user (e.g., via the user interface 110), the conversion engine 138 can be programmed and/or include executable code to convert the contents portion of the shopping list data structure to the selected format.

FIG. 2 is a block diagram of an exemplary shopping list reception system 200 that can be implemented by a portable electronic device 205 in accordance with some embodiments of the present disclosure to receive contents portion of the shopping list data structure from the system 100. The portable electronic device 205 can be implemented as, for example, a mobile phone, a tablet computer, laptop computer, and/or any other suitable portable electronic device. In exemplary embodiments, the system 200 can be implemented as an application on the portable electronic device 205 (e.g., a smart phone application). The system 200 can include a user interface 210, a positioning engine 220, and a code reader 230.

The user interface 210 can include a graphical user interface (GUI) 212 that programmed and/or include executable code to display a shopping list on a display of the portable electronic device based on the contents portion of the shopping list data structure received by the system 200 from the system 100. In some embodiments, the user can interact with the GUI 212.

As the user shops in the physical retail location, the user interface 210 can be programmed and/or include executable code to allow the user to keep track, via the GUI 212, of which products the user has already obtained and which products the user still requires. As one example, as the user shops at the physical retail location, the user can identify products on the list that the user has obtained and can interact with the GUI 212 to indicate that the products have been obtained. For example, via the GUI 212 the user can place a check mark next to the products that have been obtained and/or can cross out the products that have been obtained.

In an exemplary embodiment, the system 200 can be programmed and/or include executable code to include a floor plan (or layout) of the physical retail location to provide a map of the physical retail location to the user. The positioning engine 220 can be programmed and/or include executable code to map the location of the products associated with the shopping list and can provide a real-time view of the user's position with respect to a location of the products. As one example, in one embodiment, the positioning system 220 can be implemented as a global positioning system. As another example, in one embodiment, the physical retail location can include several wireless access points distributed throughout the store which can be in communication with the system 200 to monitor the position of the portable electronic device associated with the user. For embodiments that use the wireless access point devices in the physical retail location, the system can use triangulation techniques to determine the location of the user in the physical retail location.

In exemplary embodiments, the user can use the code reader 230 of the system 200 in conjunction with a camera of the portable electronic device 205 to scan the bar code or QR code on the packaging of the product to determine whether the product corresponds to a product on the shopping list. In some embodiments, if the product corresponds to the product on the shopping list the product an indicator (e.g., a check mark, strike through) can be programmatically inserted into the list by the user interface 210 to indicate, via the GUI 212, that the product has been obtained. Otherwise, the user interface 210 can be programmed and/or include executable code to indicate, via the GUI 212, that the product does not correspond to any of the products on shopping list.

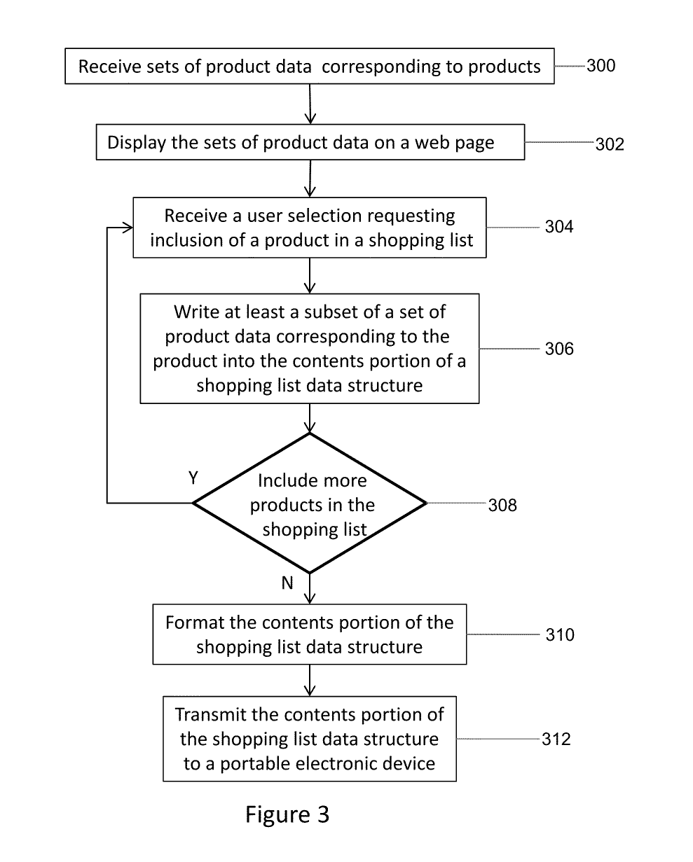

FIG. 3 is a flowchart of an exemplary shopping list generation process that can be implemented by an exemplary embodiment of the system 100. A user can visit a retail entity's website to browse for products available for purchase, such as goods and/or services. In some embodiments, the user can perform a search, such as a keyword search or can search by following links embedded in the website. Products resulting from the search can be displayed to the customer. For example, the server hosting the website can query a database that stores product data and can receive the sets of product data from the database (step 300). The sets of product data can correspond to products and can be displayed on a web page of the website (step 302). In some embodiments, the sets of product data corresponding to the products can be displayed to the user without performing a search. The user can review the product data and can select a link associated with one or more of the sets of product data to initiate one or more actions. For example, the user can request to add a product to a shopping list by selecting a link associated with one of the sets of product data (step 304) and the system 100 can be programmed and/or include executable code to write at least a subset of the set of product data corresponding to the product into contents portion of a shopping list data structure (step 306). Other actions can be performed in response to selection of links on the website. For example, in some embodiments, the user can select a link to add the product to a virtual shopping cart if the user is considering purchasing the product via the website and/or can select a link that displays additional product data from the set of product data on the website that corresponds to the product, such as detailed views of the product, product specification, product reviews, and/or any other product information.

If the user wishes to include additional products in the shopping list (step 308), the user can request to add another product to a shopping list by selecting links associated with the sets of product data associated with the respective products (step 304) and the system 100 can be programmed and/or include executable code to write at least a subset of the set of product data corresponding to the product into contents portion of the shopping list data structure (step 306). The user can continue to add products to the shopping list. If no more products are to be added to the shopping list, the system 100 can be programmed and/or include executable code to format the contents portion of the shopping list data structure (step 310) and the contents portion of the shopping list data structure can be transmitted to a portable electronic device (step 312).

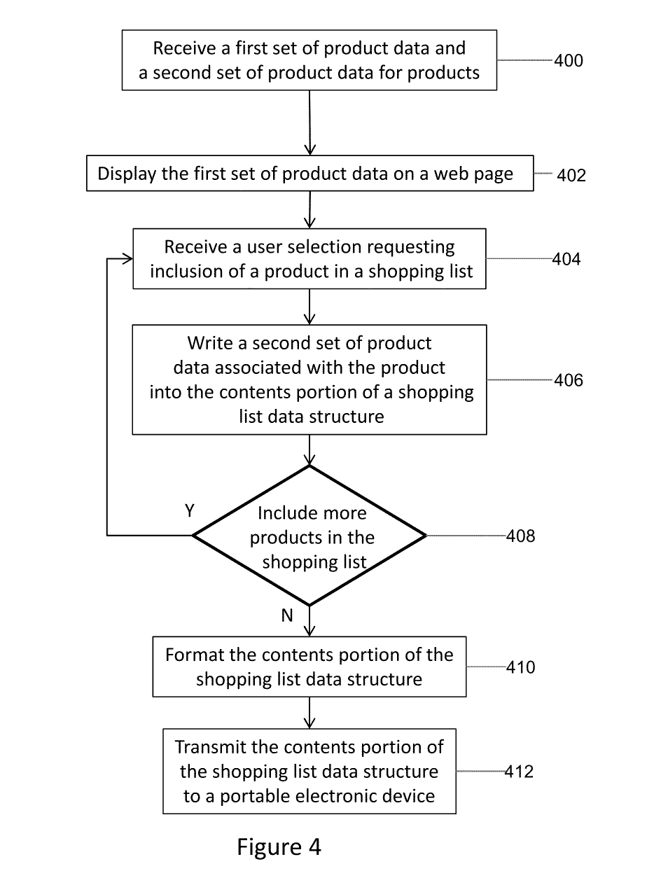

FIG. 4 is a flowchart of another exemplary shopping list generation process that can be implemented using one exemplary embodiment of the system 100. A server hosting a website can query a database that stores product data and can receive a first set of product data and a second set of product data from the database (step 400). The first set of product data can correspond to a product and can be displayed on a web page of the website (step 402). The user can review the first set of product data and can select links associated with the first sets of product data to initiate one or more actions. For example, the user can request to add a product to a shopping list by selecting a link associated with one of the first sets of product data (step 404) and the system 100 can be programmed and/or include executable code to write the second set of product data corresponding to the product into a contents portion of a shopping list data structure (step 406). Other action can be performed in response to selection of links on a web page of the website. For example, the user can select a link to add the product to a virtual shopping cart if the user is considering purchasing the product via the website and/or can select a link that displays additional product data from the first set of product data on the web page that corresponds to the product, such as detailed views of the product, product specification, product reviews, and/or any other product information.

If the user chooses to include additional products in the shopping list (step 408), the user can request to add another product to a shopping list by selecting a link associated with a first set of product data for the respective product (step 404) and the system 100 can be programmed and/or include executable code to write a second set of product data associated with the respective product into contents portion of a shopping list data structure (step 406). The user can continue to add products to the shopping list. If no more products are to be added to the shopping list (step 408), the system 100 can be programmed and/or include executable code to format the contents portion of the shopping list data structure (step 410) and the contents portion of the shopping list data structure can be transmitted to a portable electronic device (step 412).

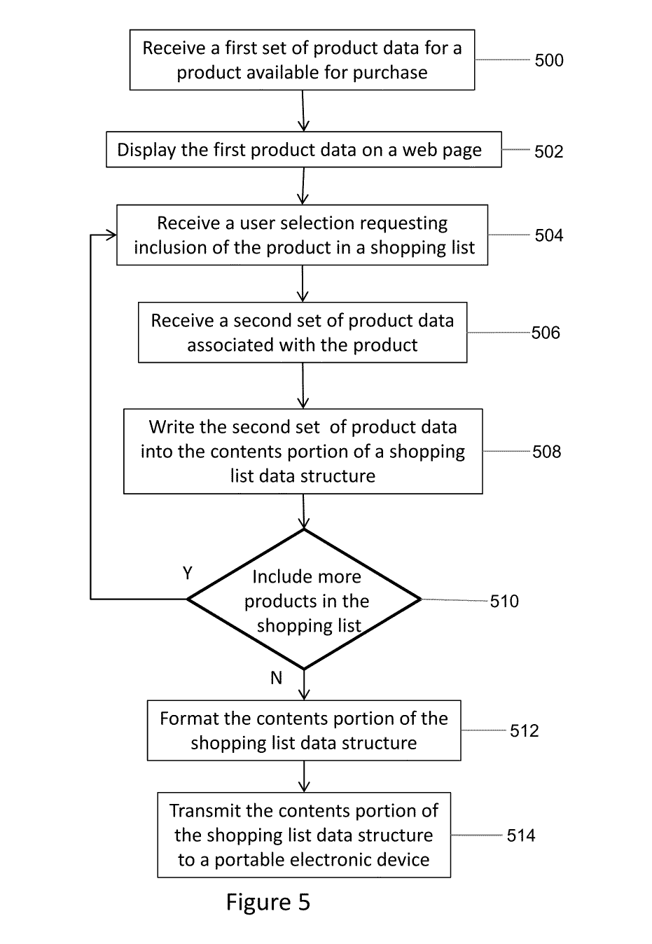

FIG. 5 is a flowchart of another exemplary shopping list generation process that can be implemented by an exemplary embodiment of the system 100. A server hosting a website can query a database that stores product data and can receive a first set of product data for a product available for purchase (step 500). The first set of product data can be displayed on a web page of the website (step 502). The user can review the first set of product data and can select a link associated with the first set of product data to initiate one or more actions. For example, the user can request to add the product to a shopping list by selecting a link associated with the product data (step 504). In response to the user selection, the system 100 can be programmed and/or include executable code to query the database for a second set of product data associated with the product and can receive the second set of product data from the database (step 506). The system 100 can be programmed and/or include executable code to write the second set of product data into contents portion of a shopping list data structure (step 508). Other action can be performed in response to selection of links on the website. For example, the user can select a link to add the product to a virtual shopping cart if the user is considering purchasing the product via the website and/or can select a link that displays additional product data from the first set of product data on the website, such as detailed views of the product, product specification, product reviews, and/or any other product information.

If the user wishes to include additional products in the shopping list (step 510), the user can request to add another product to a shopping list by selecting a link associated with a first set of product data associated with the respective product (step 504), the system 100 can be programmed and/or include executable code to receive a second set of product data associated with the respective product (step 506), and the system 100 can be programmed and/or include executable code to write the second set of product data associated with the product into contents portion of a shopping list data structure (step 508). The user can continue to add products to the shopping list. If no more products are to be added to the shopping list (step 510), the system 100 can be programmed and/or include executable code to format the contents portion of the shopping list data structure (step 512) and the contents portion of the shopping list data structure can be transmitted to a portable electronic device (step 514).

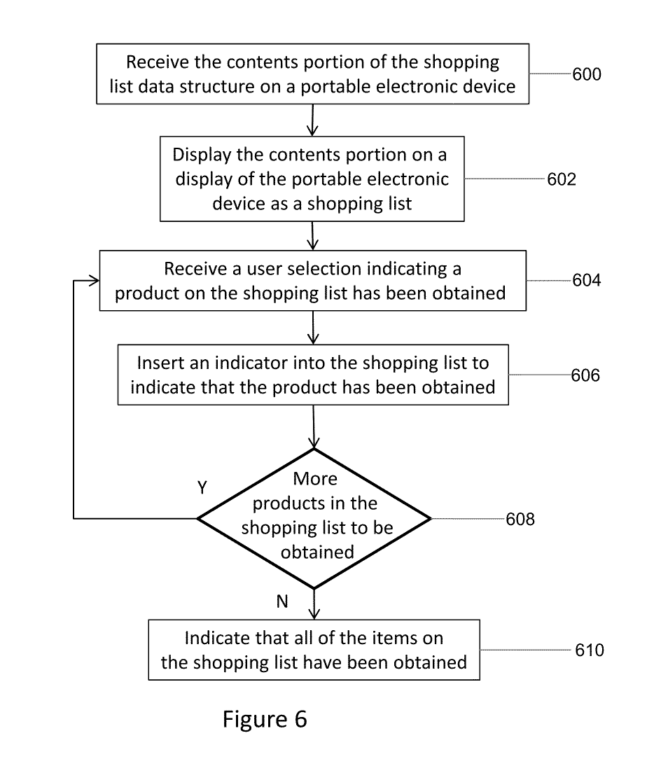

FIG. 6 is a flowchart of an exemplary shopping list display process implemented by embodiments of the shopping list reception system 200. A portable electronic device can receive contents portion of a shopping list data structure generated by a user via a retail entity's website (step 600). The system 200 can process the contents portion received by the portable electronic device and can display a shopping list of products based on the contents portion (step 602). A user of the portable electronic device can shop at a physical retail location associated with the retail entity and the system 200 can be programmed and/or include executable code to receive a user selection indicating that a product on the shopping list has be obtained (step 604). In response to the user selection, the system 200 can programmatically insert an indicator into the shopping list displayed by the portable electronic device to indicate that the product has been obtained. For example, the system 200 can programmatically insert a check mark next to the product and/or can cross out the product on the shopping list. If there are more products on the shopping list (step 608), the system 200 can repeat steps 604 and 606. Otherwise, the system 200 can be programmed and/or include executable code to indicate that all of the items on the shopping list have been obtained (step 610).

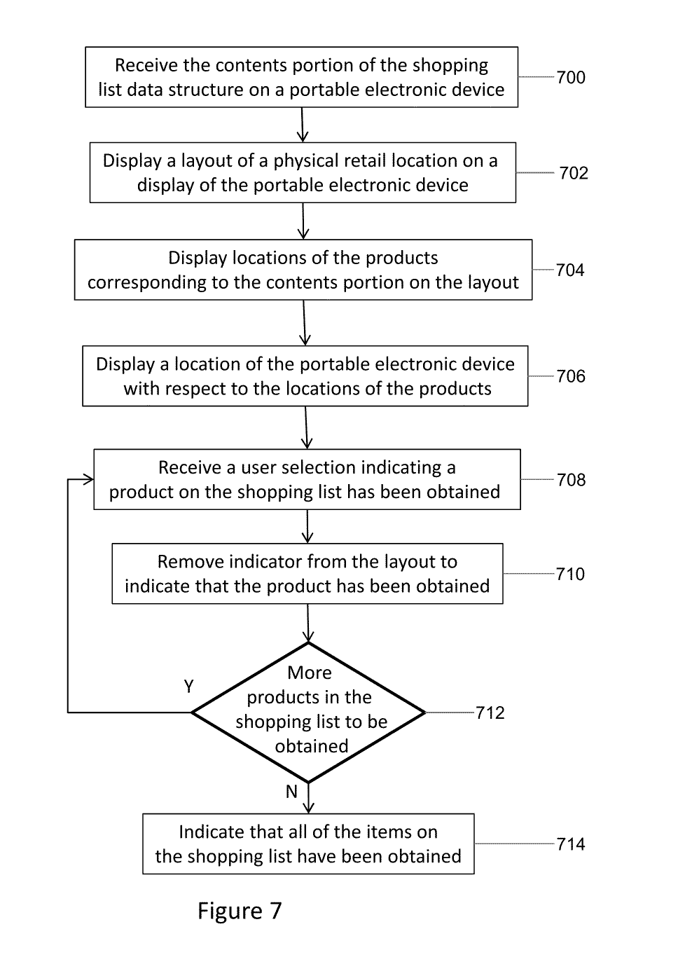

FIG. 7 is a flowchart of another exemplary shopping list display process implemented by embodiments of the shopping list reception system 200. A portable electronic device can receive contents portion of a shopping list data structure generated by a user via a retail entity's website (step 700). The system 200 can be programmed and/or include executable code to process the contents portion received by the portable electronic device and display a layout of a physical retail location on a display of the portable electronic device (step 702). A location of products in the shopping list can be displayed on the layout (step 704) and a location of the portable electronic device can be displayed with respect to the locations of the products on the layout (step 706). In some embodiments, the system 200 can be programmed and/or include executable code to selectively display the layout of the physical retail location including the locations of the products on the shopping list and the shopping list itself. A user of the portable electronic device can shop at a physical retail location associated with the retail entity and the system 200 can be programmed and/or include executable code to receive a user selection indicating that a product on the shopping list has be obtained (step 708). In response to the user selection, the system 200 can be programmed and/or include executable code to remove the product that has been obtained from the layout (step 710). For embodiments in which the shopping list can be selectively displayed, the system 200 can programmatically insert an indicator into the shopping list to indicate that the product has been obtained. If there are more products on the shopping list (step 712), the system 200 can be programmed and/or include executable code to repeat steps 706 and 708. Otherwise, the system 200 can be programmed and/or include executable code to indicate that all of the items on the shopping list have been obtained (step 714).

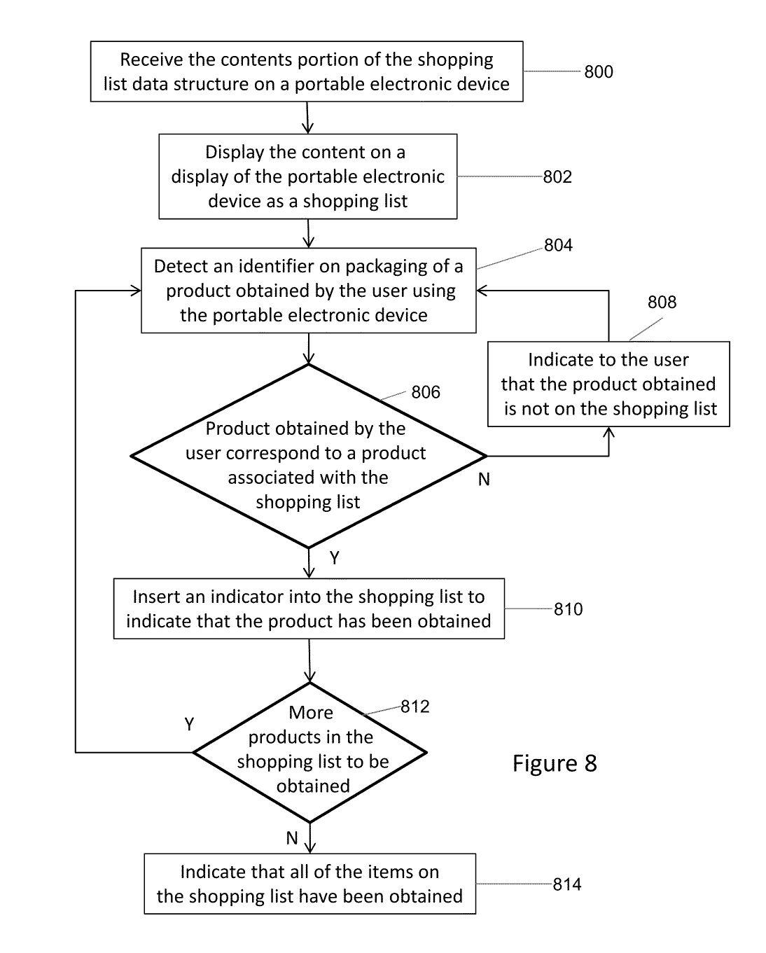

FIG. 8 is a flowchart of another exemplary shopping list display process implemented by embodiments of the shopping list reception system 200. A portable electronic device can receive data from a content portion of a shopping list data structure generated by a user via a retail entity's website (step 800). The system 200 can programmatically process the contents portion received by the portable electronic device and can display a shopping list of products based on the contents portion (step 802). A user of the portable electronic device can shop at a physical retail location associated with the retail entity. As the user shops, the user can scan identifiers on packages of products in the store using a camera of the portable electronic device and the system 200 can be programmed and/or include executable code to detect the identifier on the packaging (step 804). The system 200 can be programmed and/or include executable code to determine whether the identifier on the packaging corresponds to a product associated with the shopping list. If the identifier does not correspond to a product on the shopping list (step 806), the system 200 can be programmed and/or include executable code to indicate to the user that the product is not on the shopping list (step 808) and the system 200 can be programmed and/or include executable code to wait for the user to scan another identifier to repeat the process from step 804.

If the identifier corresponds to a product on the shopping list (step 806), the system 200 can be programmed and/or include executable code to insert an indicator into the shopping list displayed by the portable electronic device to indicate that the product has been obtained (step 810). For example, the system 200 can be programmed and/or include executable code to insert a check mark next to the product and/or can cross out the product on the shopping list. If there are more products on the shopping list (step 812), the system 200 can repeat the process from step 804. Otherwise, the system 200 can be programmed and/or include executable code to indicate that all of the items on the shopping list have been obtained (step 814).

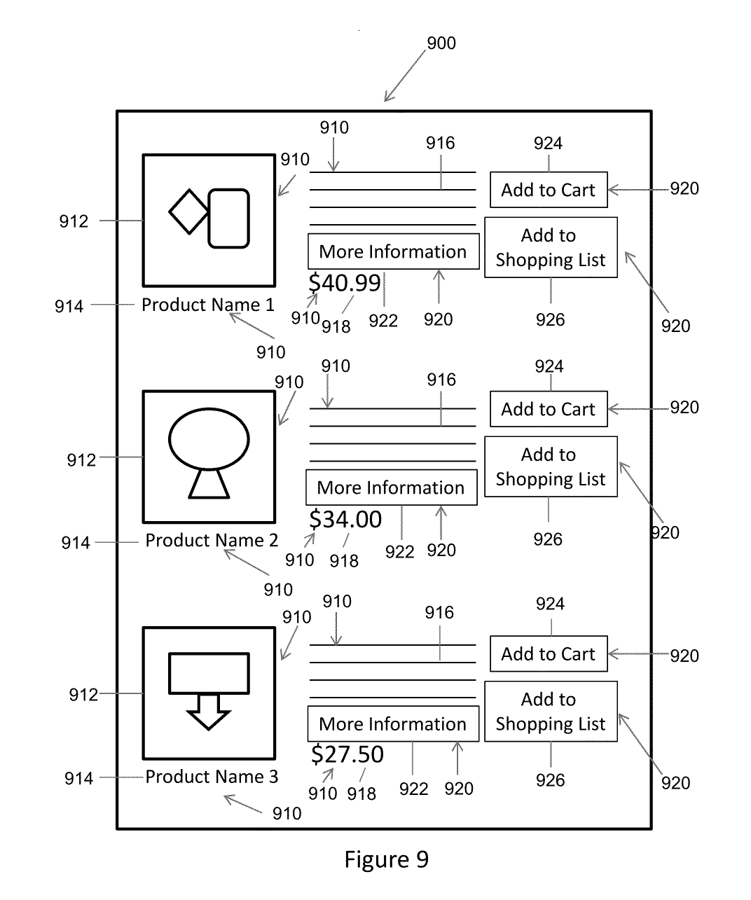

FIG. 9 is an exemplary web page 900 rendered on a display device that can display product data 910 associated with products that are available for purchase from a retail entity. The web page 900 can display the product data 910 to a user and can include a user interface to allow the user to interact with the web page 900. In this embodiment, the product data 910 for each product can include an image 912 of the product, a name 914 of the product, a description 916 of the product, and a price 918 of the product. GUI buttons 920 can be associated with each product. The GUI buttons 920 can be selected by the user to initiate one or more actions. For example, a GUI button 922 can be selected to display additional product data associated with the product, a GUI button 924 can be selected to add the product to a virtual shopping cart for online purchase of the product, and a GUI button 926 can be selected to add the product to a shopping list using an embodiment of the system 100. In some embodiments, a single GUI button can be implemented to replace the GUI buttons 924 and 926 such that the selection of the single GUI button can add the product to a general list data structure and upon a subsequent user selection can format the list as a shopping list to be output to a portable electronic device and/or can format the list as a shopping cart data structure to facilitate an online transaction to purchase the products. In some embodiments, a web page can be opened showing the product added to the shopping list in response to the selection of the GUI button 926 by the user. The web page can also include data entry fields for receiving information regarding transmission of the shopping list. For example, the data entry fields can receive a telephone number, an e-mail address, a user name, and/or any other information that can be used to transmit the shopping list to an intended recipient.

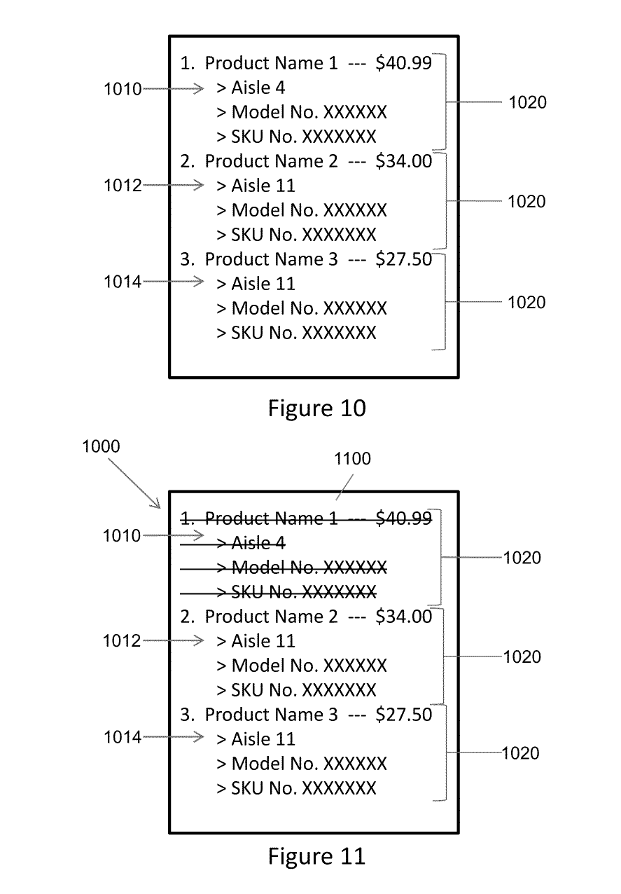

FIG. 10 is an exemplary shopping list 1000 that can be displayed on a portable electronic device. In this embodiment, the shopping list 1000 includes entries for three products 1010, 1012, 1014. Each entry 1010, 1012, 1014 can include product data 1020 including, for example, a product name, price, aisle location in the physical retail location, model number, and SKU number. In some embodiments, the shopping list can include other product data including an image of the product, a description of the products, and/or any other product data. In exemplary embodiments, the shopping list 1000 can be received as a text message (e.g., an SMS message), a multimedia message (e.g., an MMS message), an e-mail, data to be processed by an embodiment of the system 200, and/or in any other suitable form.

FIG. 11 is depicts the shopping list 1000 of FIG. 10 being displayed by a portable electronic device include an embodiment of the system 200. The system 200 can receive the shopping list and can process the shopping list to render the shopping list on a display of the portable electronic device. In this embodiment, the product data 1020 of the entry 1010 has been crossed out by the system 200 using a strike through 1100 to indicate that the product associated with the entry 1010 has been obtained by the user. The system can cross out the product data of the entry 1010 in response to an input from the user and/or in response to a detection of an identifier on the packaging of a product that corresponds to the product associated with the product data 1020 of the entry 1010

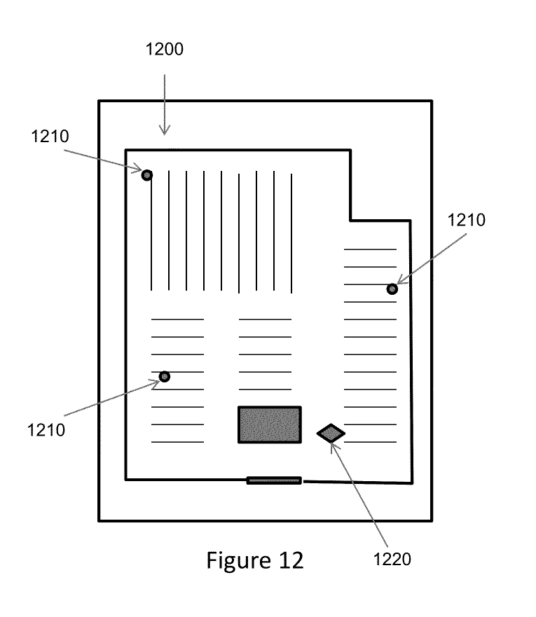

FIG. 12 is an exemplary layout 1200 of a physical retail location that can be displayed on a portable electronic device by embodiments of the system 200 using information in a shopping list received by the portable electronic device and processed by the system 200. In this embodiment, the system 200 can be programmed and/or include executable code to place indicators 1210 on the layout 1200 to indicate locations within the physical retail location at which the products of the shopping list are located. The system 200 can also be programmed and/or include executable code to place an indicator 1220 on the layout to indicate a location of the portable electronic device with respect to the products on the shopping list. As the portable electronic device is moved throughout the physical retail location, the system 200 can be programmed and/or include executable code to update the display so that the indicator 1220 corresponds to the location of the portable electronic device. Once a user has obtained a product on the list, the indicator corresponding to the product can be removed from the layout 1200. The system 200 can be programmed and/or include executable code to remove the indicator corresponding to the obtained product from the layout in response an input from the user indicating that the user has obtained the product and/or a detection of an identifier on the packaging of the product that corresponds to a product on the shopping list.

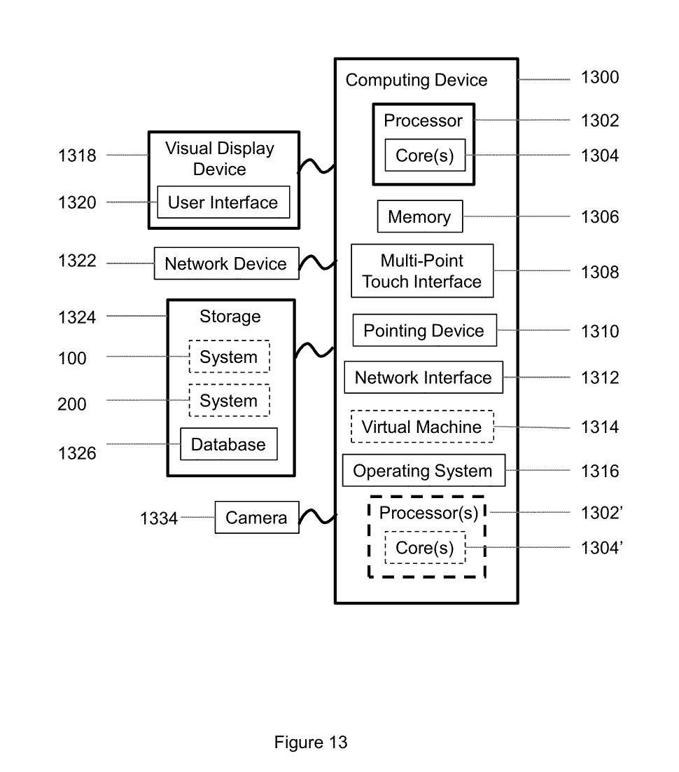

FIG. 13 is a block diagram of an exemplary computing device 1300 that can be used in to implement exemplary embodiments of the system 100 and/or the system 200. The computing device 1300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1306 included in the computing device 1300 may store computer-readable and computer-executable instructions or software for implementing exemplary embodiments. The computing device 1300 also includes processor 1302 and associated core 1304, and optionally, one or more additional processor(s) 1302′ and associated core(s) 1304′ (for example, in the case of computer systems having multiple processors/cores), for executing computer-readable and computer-executable instructions or software stored in the memory 1306 and other programs for controlling system hardware. Processor 1302 and processor(s) 1302′ may each be a single core processor or multiple core (1304 and 1304′) processor.

Virtualization may be employed in the computing device 1300 so that infrastructure and resources in the computing device may be shared dynamically. A virtual machine 1314 may be provided to handle a process running on multiple processors so that the process appears to be using only one computing resource rather than multiple computing resources. Multiple virtual machines may also be used with one processor.

Memory 1306 may include a computer system memory or random access memory, such as DRAM, SRAM, EDO RAM, and the like. Memory 1306 may include other types of memory as well, or combinations thereof.

A user may interact with the computing device 1300 through a visual display device 1318, such as a computer monitor, which may display one or more user interfaces 1320 that may be provided in accordance with exemplary embodiments. The computing device 1300 may include other I/O devices for receiving input from a user, for example, a keyboard or any suitable multi-point touch interface 1308, a pointing device 1310 (e.g., a mouse). The keyboard 1008 and the pointing device 1310 may be coupled to the visual display device 1318. The computing device 1000 may include other suitable conventional I/O peripherals.

The computing device 1300 may also include one or more storage devices 1324, such as a hard-drive, CD-ROM, or other computer readable media, for storing data and computer-readable instructions and/or software that implement exemplary embodiments of the system 100 and/or system 200 described herein. For example, the storage device can store an executable instance of the system 100 for embodiments in which the computing device is configured as, for example, a server, or can store an executable instance of the system 200 for embodiments in which the computing device is configured as a portable electronic device. Exemplary storage device 1324 may also store one or more databases for storing any suitable information required to implement exemplary embodiments. For example, exemplary storage device 1324 can store one or more databases 1326 for storing information, such as sets of product data, shopping list data structures, the contents portion of the shopping list data structures, physical retail layouts, and/or any other information to be used by embodiments of the system 100 and/or system 200. The databases may be updated at any suitable time to add, delete, and/or update one or more items in the databases.

The computing device 1300 can include a network interface 1312 configured to interface via one or more network devices 1322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1312 may include a built-in network adapter, network interface card, PCMCIA network card, card bus network adapter, wireless network adapter, USB network adapter, modem or any other device suitable for interfacing the computing device 1300 to any type of network capable of communication and performing the operations described herein. Moreover, the computing device 1300 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 1300 may run any operating system 1316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1316 may be run in native mode or emulated mode. In an exemplary embodiment, the operating system 1316 may be run on one or more cloud machine instances.

In some embodiments, the computing device 1300 can be communicatively coupled to a camera 1334. For example, when the computing device 1300 is configured as a portable electronic device that includes the system 200, the camera 1334 can be used by the system 200 to implement the coder reader 230 of the system 200 (FIG. 2).

FIG. 14 is a block diagram of an exemplary computing system 1400 configured to implement one or more embodiments of the system 100 and/or system 200. The computing system 1400 includes servers 1410-1414 that can be operatively coupled to clients 1420-1422, via a communication network 1450, which can be any network over which information can be transmitted between devices communicatively coupled to the network. For example, the communication network 1450 can be the Internet, Intranet, virtual private network (VPN), wide area network (WAN), local area network (LAN), and the like. The computing system 1400 can include repositories or database devices 1430, 1431, which can be operatively coupled to the servers 1410-1414, as well as to clients 1420-1422, via the communications network 1450. The servers 1410-1414, clients 1420-1422, and database devices 1430-1432 can be implemented as computing devices. Those skilled in the art will recognize that the database devices 1430-1432 can be incorporated into one or more of the servers 1410-1414 such that one or more of the servers can include databases.

In some embodiments, the system 100 can be implemented by a single device, such as server 1410 and/or server 1411. In some embodiments, the system 100 can be distributed among different devices (e.g., servers, clients, databases) in the communication network 1450 such that one or more components of the system 100, or portions thereof, can be implemented by different devices in the communication network 1450. For example, in illustrative embodiments, the user interface 110 can be implemented by a server 1414 and the generator or portions thereof can be implemented by the server 1413.

In an exemplary embodiment, servers 1410, 1412, and 1414 can be servers configured to host web pages, such as web pages 1440 associated with one or more retail entities, which are configured to facilitate display of products 1442 using first sets of product data 1433 that can be stored, for example, in database 1430. Clients 1420-1422 can represent computing devices having a client-side application 1423, such as a web browser, smart phone application, or any other suitable client-side application that permits the clients 1420-1422 to interact with one or more of the servers 1410-1414. In the present embodiment, client 1422 can be a portable electronic device that includes an embodiment of the system 200.

Embodiments of the system 100 can be associated with one or more web pages 1440 from which products 1442 can be viewed and/or purchased via clients 1420-1422. For example, the system 100, or a portion thereof, and one or more of the web pages 1440 can be implemented together on one or more of the servers 1410-1414 and/or the system 100 can be implemented on a separate server that is in communication with servers that implement the one or more web pages 1440.

In an exemplary operation, the customers can visit one or more of the web pages 1440 hosted by the servers 1410, 1412, and 1414 using the client-side application 1423 via the communications network 1450 and the customers can browse the web pages 1440 for products 1442 available for purchase. When a customer identifies one or more products 1442 in which the customer is interested, the customer can add the products 1442 to a shopping list that can be output by the system 100 to a portable electronic device (e.g., client 1422). For example, the shopping list can be transmitted to the portable electronic device using SMS, MMS, e-mail, and/or any other suitable format.

For embodiments in which the system 200 is implemented on the server 1410, the system 200 can be integrated with the web page 1440 so that the user interface 110 of the system 100 can be included in the web page 1440. For embodiments in which the system 100 is implemented on a separate server than the website 140 (e.g., servers 1411, 1412), the server 1411 can communicate with the server 1412 to implement embodiments of the system 100. For example, the servers 1411 and 1412 can communicate over the communications network 1450 and/or can communicate via another connection, such as a direct connection or via another communication network, which is illustrated as a dashed line between the servers 1411 and 1412 in FIG. 14. For embodiments in which the system 100 is distributed on different servers (e.g., 1413-1414), the user interface 110 of the system can be integrated with the web page 1440 hosted server 1413, which can be in communication with the servers 1414 and 1415 to implement embodiments of the system 100. Furthermore, embodiments of the system 100 can be in communication with the databases 1430-1432 to store and/or retrieve information and/or parameters, such as the first sets of product data 1433, the second sets of product data 1434, the shopping list data structures 132, and/or any other information to facilitate embodiments of the system 100.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method of processing a user selection on a retail website and transmitting information corresponding to the user selection to a portable electronic device in an electronic commerce environment, the method comprising:
receiving a user selection from a user via a web browser, the user selection being associated with a selected product displayed via a web page of a retail website;
writing information related to the selected product into a contents portion of a shopping list data structure in response to the user selection; and
transmitting the contents portion of the shopping list data structure to a portable electronic device via a data communications network.

2. The method of claim 1, wherein a first set of product data is displayed on the web page for the selected product.

3. The method of claim 2, wherein the first set of product data includes at least one of a name of the product, a price of the product, a description of the product, a stock keeping unit number associated with the product, or an image of the product.

4. The method of claim 2, wherein the information related to the selected product comprises a sub-set of the first set of product data.

5. The method of claim 2, further comprising retrieving the first set of product data from a database in response to a query from a user, the first set of product data corresponding to the selected product available for purchase at a physical retail location.

6. The method of claim 5, further comprising retrieving a second set of product data from the database in response to the query, the second set of product data corresponding to the selected product available for purchase at the physical retail location.

7. The method of claim 6, wherein the second data set includes an isle at which the product is located in the physical retail location.

8. The method of claim 6, wherein the first data set includes product data having a first file format and the second data set includes product data having a second file format.

9. The method of claim 6, wherein the first data set and the second data set have overlapping product data and non-overlapping product data.

10. The method of claim 6, wherein writing information related to the product comprises writing the second data set into the contents portion of the shopping list data structure in response to the user selection.

11. The method of claim 2, wherein writing at least a portion of the product data comprises:
querying the database for a second data set in response to the user selection;
receiving the second data set; and
writing the second data set into the contents portion of the shopping list data structure.

12. The method of claim 1, wherein transmitting the contents portion comprises sending the at least one of a SMS message or a MMS message to the portable electronic device.

13. A non-transitory computer readable medium storing instructions, wherein execution of the instructions by a processing device causes the processing device to implement a process comprising:
receiving a user selection from a user via a web browser, the user selection being associated with a selected product displayed via a web page of a retail website;
writing information related to a selected product into a contents portion of a shopping list data structure in response to a user selection via the web browser, the user selection being associated with the selected product; and
transmitting the contents portion of the shopping list data structure to a portable electronic device via a data communications network.

14. The medium of claim 13, wherein execution of the instruction by the processing device causes the processing device to display a first set of product data is displayed on the web page for the selected product.

15. The medium of claim 14, wherein the information related to the selected product comprises a sub-set of the first set of product data.

16. The medium of claim 13, wherein execution of the instructions by the processing device cause the processing device to retrieve a second set of product data from the database, the second set of product data corresponding to the selected product.

17. The medium of claim 16, wherein the second data set includes an isle at which the product is located in the physical retail location.

18. The medium of claim 16, wherein the first data set and the second data set have overlapping product data and non-overlapping product data.

19. The medium of claim 16, wherein writing information related to the product comprises writing the second data set into the contents portion of the shopping list data structure in response to the user selection.

20. The medium of claim 14, wherein writing the information related to the selected product comprises:
querying the database for a second data set in response to the user selection;
receiving the second data set; and
writing the second data set into the contents portion of the shopping list data structure.

21. The medium of claim 13, wherein transmitting the contents portion comprises sending the at least one of a SMS message or MMS message to the portable electronic device.

22. A system for electronic commerce associated with a website, the system comprising:
a network interface communicatively coupled to a communications network; and
a configurable processing device communicatively coupled to the network interface, the processing device configured to:
receive a user selection over the communications network from a user via the network interface, the user selection corresponding to a selected product displayed on a web page of a retail website by a web browser;
write information related to the selected product into a contents portion of a shopping list data structure in response to the user selection; and
transmit the contents portion of the shopping list data structure to a portable electronic device via the network interface.

23. The system of claim 22, wherein the processing device receives a first set of product data and a second set of product data from a database, the first set of product data being displayed on the web page for the selected product and the second set of product data being written into the contents portion of the shopping list data structure, the second set of product data corresponding to the selected product available for purchase at the physical retail location.
